(19) United States
(12) Patent Application Publication
(10) Pub. No.: US 2026/0240704 A1
(43) Pub. Date: Aug. 20, 2026

(54) Inflatable Patient Positioning and Transfer Apparatus

(71) Applicant: EHOB, Inc., Indianapolis, IN (US)

(72) Inventors: Gregory R. Konkle, Indianapolis, IN (US); Christian Garrison Gastaldo, Indianapolis, IN (US); Taylor Brooks, Noblesville, IN (US); Jared Scott Cohen, Indianapolis, IN (US); James Pittard, McCordsville, IN (US); Heike Roessiger, Indianapolis, IN (US)

(21) Appl. No.: 19/560,849

(22) Filed: Mar. 9, 2026

Related U.S. Application Data
(62) Division of application No. 18/985,994, filed on Dec. 18, 2024.

(51) Int. Cl. A61G 7/10

(52) U.S. Cl. CPC A61G 7/1028; A61G 2200/327

(57) ABSTRACT

A mobile cart and a lifting handle are provided for supporting an air pump. The cart includes a base with a plurality of wheels, a post projecting upward from the base, and a spool mounted to a distal end of the post, the spool having a cylindrical body arranged perpendicular to the post. The lifting handle includes a fastener portion for fastening to the air pump and a one-piece body defining a grip portion configured to be manually grasped by a user to carry the air pump fastened to the lifting handle, and a hook portion configured to removably engage the cylindrical body of the spool to support the air pump, fastened to the pump handle, on the post of the cart.

### PRIORITY CLAIM

This application is a divisional of and claims priority to pending U.S. application Ser. No. 18/985,994, filed on Dec. 18, 2024.

### BACKGROUND

Non-ambulatory patients who must be supported and moved in a patient facility such as a hospital or a nursing home present substantial challenges when a course of treatment requires moving the patient from one location to another. A patient, for example, may need to be moved from a hospital bed, which must remain in the patient's room, to a stretcher and then from the stretcher to a treatment location such as a surgical table in an operating room. Following treatment, the reverse patient handling sequence must occur, i.e., the patient must be moved from the surgical table, which remains in the operating room, to a stretcher which travels to the patient's hospital room, and then from the stretcher back onto the bed in the hospital room. In a very large percentage of such occurrences the patient must be handled in a fashion which requires only a minimum of movement of the patient with respect to a supporting surface. In the case of a patient being returned to a hospital room following surgery, for example, the patient's body may not be able to withstand the stresses and strains of being lifted from a stretcher to the bed when one or even several hospital personnel combine their efforts to make such a transfer.

The same challenge of moving a patient with minimum handling exists in non-surgical settings as well. The bariatric patient is a common example. When such a patient is morbidly obese, transferring presents difficulties for both the patient and the care facility staff. Movement of a morbidly obese person often requires the hospital staff to physically lift and/or slide the patient from an at-rest position on a hospital bed to an at-rest position on a stretcher a total of four times to complete a single treatment cycle, such as surgery. The staff must perform the task of lifting and/or sliding such a patient because in nearly all instances the patient, due to the physical condition of obesity and/or illness, simply cannot personally do the task.

A further complication with patient handling systems as above described is that, even with the best intentioned and caring staff, the patient very often suffers substantial discomfort. The simple act of sliding a patient over a flat surface can be very painful to a patient who has had surgical incisions which are far from healed, for example. These problems can be alleviated by the use of an air mattress onto which the patient is placed while in his bed and which is then placed onto a gurney. A problem common to all such devices is that invariably the air mattress has the general characteristic of a balloon, in the sense that when one area is indented another remote area will bulge, thus creating an unstable condition. The unstable condition can lead to the patient shifting dangerously on a stretcher or gurney during a patient transfer, or even on a stationary bed. Only if the patient lies perfectly flat and perfectly still on the air mattress, and if there are no anomalies are in the travel path of the gurney, can the probabilities of an accident be lessened.

### SUMMARY

A patient support and transfer apparatus includes an inflatable body having a length from a head end to a foot end and a width transverse to the length that is formed by a bottom sheet and a top sheet sealed to the bottom sheet around an outer perimeter of the inflatable body to define an enclosed interior of the body. An air intake manifold is provided at the foot end of the inflatable body including at least one air inlet port in communication with the enclosed interior and configured to connect to an air supply hose of an air pump. In one aspect, the top and bottom sheets are connected at a central portion by a plurality of Y-shaped baffles in the interior of the inflatable body, extending along a portion of the width of the body.

In another aspect, the bottom sheet of the inflatable body includes two substantially rectangular aperture arrays extending parallel to each other along a length of the inflatable body and spaced apart from each other and from the outer perimeter of the inflatable body. Each of the aperture arrays including a plurality of small-diameter apertures to allow pressurized air within the inflatable body to bleed out and create an air cushion for moving the apparatus. The rectangular aperture arrays are generally aligned with the plurality of Y-shaped baffles, and are offset from the sides of the perimeter of the inflatable body to form inflatable side pontoons. The side pontoons are sized to provide an optimum cocooning effect for the patient. An aperture array is provided in each side pontoon with a limited number of apertures relative to the two rectangular aperture arrays.

In another aspect of the disclosure, the air intake manifold includes an elongated first manifold sock extending across the width of the inflatable body at the foot end. The first sock has a first air inlet port at one end configured to connect to an air supply hose of an air pump and a closed opposite end. The manifold includes a second manifold sock extending across the width of the inflatable body at the foot end and overlaying the first manifold sock. The second manifold sock has a second air inlet port at one end adjacent the closed opposite end of the first manifold sock, and a closed opposite end adjacent the first air inlet port of the elongated first manifold sock. Each of the first and second elongated manifold sock includes at least one opening in communication with the enclosed interior of the body. The air pump can be connected to either of the two manifold socks to supply pressurized air to the interior cavity of the inflatable body. When one sock is pressurized, it inflates to compress and close off the other manifold sock.

An apparatus is provided for supporting the air pump and allowing for easy transport of the air pump to and from the inflatable patient support and transfer apparatus. A mobile cart is provided with a vertical post having a cylindrical spool at the top of the post. A handle is provided that is connected to the air pump and includes a hook portion that can be removably mounted on the spool to support the air pump. The handle can otherwise be used to independently transport the air pump as needed.

### BRIEF DESCRIPTION OF THE DRAWINGS

FIG. 1 is a bottom view of a patient support and transfer apparatus according to one embodiment of the present disclosure.

FIG. 2 is a top view of the apparatus shown in FIG. 1.

FIG. 3 is an enlarged side cross-sectional view of the aide panel of the apparatus shown in FIGS. 1-2.

FIGS. 4A-4B are top and side views of a handle of the apparatus shown in FIGS. 1-2.

FIG. 5A is an enlarged side view of an interior baffle of the apparatus shown in FIGS. 1-2, with the baffle appearing in an uninflated condition of the apparatus.

FIG. 5B is a side view of the baffle shown in FIG. 5A, but with the baffle appearing in an inflated condition of the apparatus.

FIG. 6 is a perspective view of the apparatus of FIGS. 1-2, shown in its inflated condition.

FIGS. 7A-7B are bottom and top views of another version of the patient support and transfer apparatus disclosed herein, particularly for use by a larger patient.

FIGS. 8A-8B are bottom and top views of another version of the patient support and transfer apparatus disclosed herein, particular for use with a patient lifting apparatus.

FIG. 9 is a top view of a lifting handle of the apparatus shown in FIGS. 8A-8B.

FIG. 10 is a top view of another handle of the apparatus shown in FIGS. 8A-8B.

FIG. 11 is a front view of an air pump for use with any of the patient support and transfer apparatuses shown in the prior figures.

FIGS. 12A-12B are perspective views of the air pump of FIG. 11 supported in a pump cart according to one aspect of the present disclosure.

FIG. 13 is a perspective view of the pump cart shown in FIGS. 12A-12B.

FIG. 14 is an enlarged perspective view of a pump handle for use with the air pump and cart shown in FIGS. 11-13.

FIG. 15 is an enlarged perspective view of a spool of the pump cart of FIG. 13 for supporting the pump handle of FIG. 14.

### DETAILED DESCRIPTION

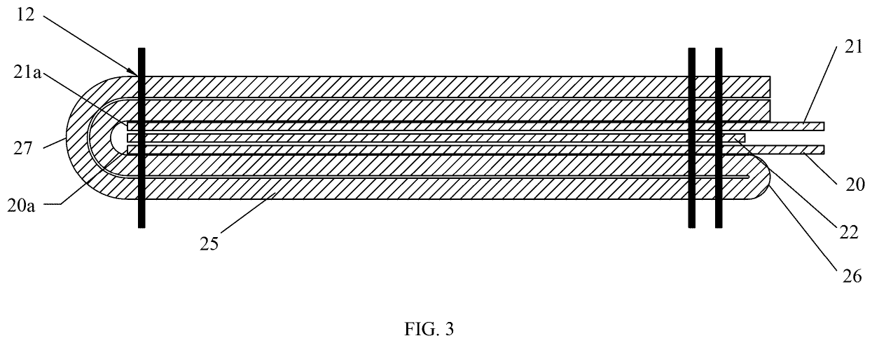

A patient support and transfer apparatus 10 includes an inflatable body 11, side strips 12 and an air intake manifold 13. The inflatable body 11 is formed by a bottom sheet 20 and a top sheet 21 that are sealed around the common perimeter. One or both of the sheets can be folded to form an intermediate flap 22 around the perimeter, as shown in FIG. 3. The two sheets can be formed of vinyl, nylon, a polyethylene, a polypropylene, a polyurethane, or a similar material that is strong and rip-resistant to handle the significant shear forces that can arise when moving a patient. In the illustrated embodiments, the two sheets 20, 21 are nylon with a thickness in the range of 0.09-0.15 mm. The perimeter of the two sheets and the intermediate flap are sealed by stitching 30 around the entire perimeter of the sheets. Preferably, the stitching includes two lines of stitching about one (1) cm apart to form a sealed margin around the perimeter.

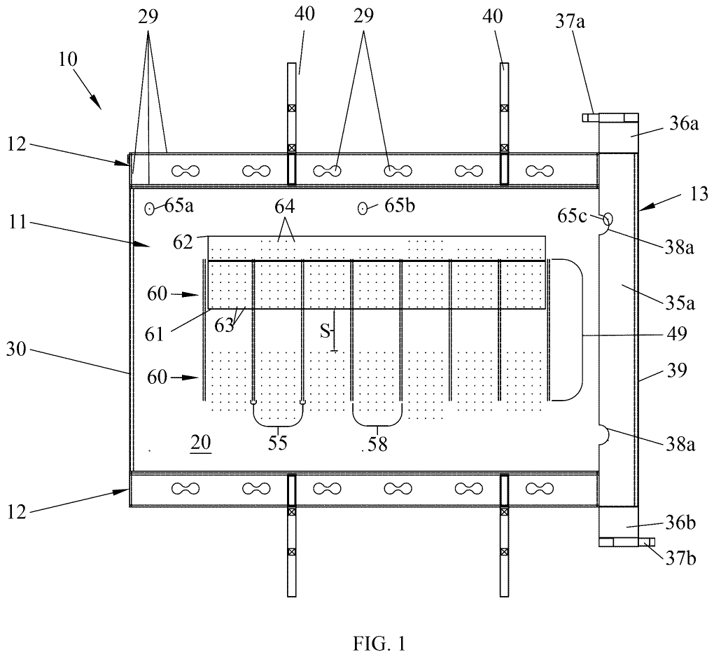

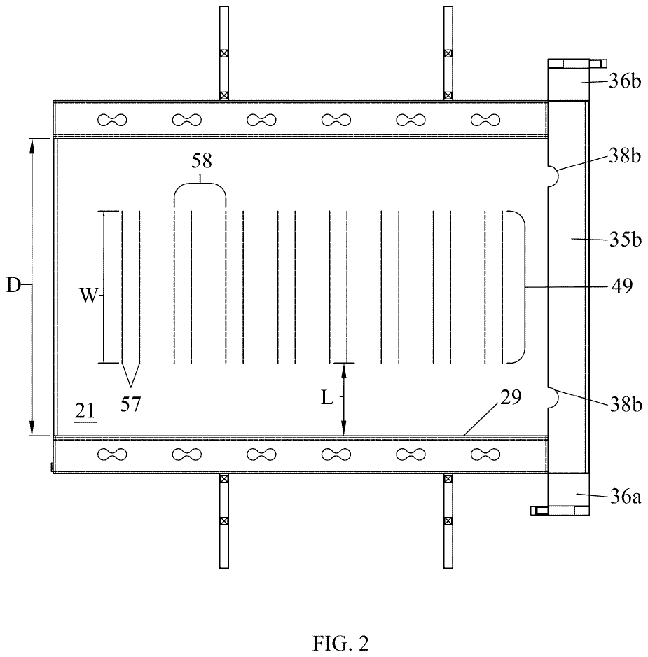

The top and bottom sheets 20, 21 are generally rectangular and define an area sized to cover a substantial portion of a patient bed. Preferably, the width is slightly greater than the width of the bed to allow for easy access to handles 28 formed in the side strips 12, which are described in more detail herein. The width can be between 30 inches and 45 inches. For the apparatus 10 shown in FIGS. 1-2, the overall width is 42 inches. The length of the transfer sheet is sufficient to receive at least the patient's torso and upper leg, and in one embodiment to extend from the at least the neck to the knees of the patient. The length in a preferred embodiment is sufficient to extend from the head to the legs of a patient who is 6 feet tall. Thus, the overall length can be at least 39 inches and less than 72 inches. For the apparatus 10 shown in FIGS. 1-2, the length is 60 inches. The sheets can be provided in three distinct lengths—39, 56 and 72 inches—to accommodate different heights of patients. The bottom sheet can be provided with a coating to reduce the coefficient of friction of the bottom surface to facilitate sliding the apparatus 10 on a bed, gurney or other structure. The top sheet can have an upper surface with a greater coefficient of friction than the bottom surface, to prevent the patient from sliding on the top sheet during use.

The side strips 12 are formed around the sides of the top and bottom sheets, overlapping the stitching 30 used to seal the perimeter of the two sheets 20, 21 together. As shown in more detail in FIG. 3, the side strips 12 are formed by a single sheet 25 that is folded in half at fold 26 and then folded in half again at fold 27 around the side edges 20a, 21a of the sheets 20, 21. The side strips 12 thus include four layers of the sheet 25 folded around at least two sheets 20, 21 of the inflatable body, or more if the folded flap 22 is included. All of the layers are stitched together at stitching 29 around the entire perimeter of the side strips 12, as shown in FIG. 1. The side strips 12 do not extend along the entire length of the top and bottom sheets 20, 21, but instead terminate at the intake manifold 13 of the apparatus 10. The stitching 29 of the side strips can help define the ends of the intake manifold. The single sheet 25 that forms the side strips is made of a non-woven, tear-resistant material. In the illustrated embodiments, the side strips 12 have a thickness of 1.5-2.0 mm.

The multi-layer structure of the side strips 12 provides a very strong base for the handles 28 defined along the length of the side strips. In one embodiment, the handles are in the form of openings cut into each of the layers and having a “dog-bone” shape, as disclosed in U.S. Pat. No. 8,281,436, which issued on Oct. 9, 2012 to the applicant of the present application, the entire disclosure of which is incorporated herein by reference. The handles 28 are spaced along the length of the side strips at optimum locations to be grasped with both hands by two or more medical personnel when moving a patient resting on the inflatable apparatus 10. In a preferred embodiment, the side strips 12 have a constant width along their length of 4.0 inches (102 mm), which provides sufficient space to form the “dog-bone” handles 28.

The inflatable body 11 receives air under pressure through the intake manifold 13 of the apparatus 10. The manifold includes two manifold socks 35a (FIG. 1) and 35b (FIG. 2) disposed within the inflatable body 11 at the foot end of the apparatus that overlay each other. It is noted that the manifold could be arranged at the head end of the apparatus, but it has been found that the presence of the inflation equipment near the head of the patient is disturbing to the patient. In the illustrated embodiment, each manifold sock 35a, 35b is formed from an air-impermeable sheet that is folded over at the foot end of the two sheets 20, 21 and then attached to the sheets and sealed by stitching 39 along the width of the two sheets. The stitching 39 thus forms the sealed perimeter of the two sheets, as well as defines the tubular configuration of the two manifold socks 35a, 35b. The manifold sock 35a is open at an inlet port 36a at one end and is sealed at its opposite end at the inlet port 36b. Similarly, the manifold sock 35b is open at the inlet port 36b and sealed at its opposite end at the inlet port 36a. Each inlet 36a, 36b is a flexible inlet sewn to each open end of the inlet manifold sock, and in particular sewn to the open end of the respective manifold sock 35a, 35b, as well as to the bottom sheet 20 at the bottom of the manifold and to the top sheet 21 at the top of the manifold sock. Each manifold sock 35a, 35b is thus anchored to the inflatable body 11 at the intake manifold 13 of the body. The inlet ports 36a, 36b are anchored to the ends of the corresponding manifold sock and to the top and bottom sheets 20, 21. Each inlet port 36a, 36b include straps 37a, 37b at the ends of the ports that can be used to engage the hose of an inflation device used to pump air into the inflatable body 11 or can be used to close the respective port. Ports 36a, 36b are provided on opposite sides of the apparatus 10 to accommodate positioning the inflation device on either side of the patient's bed, gurney, etc.

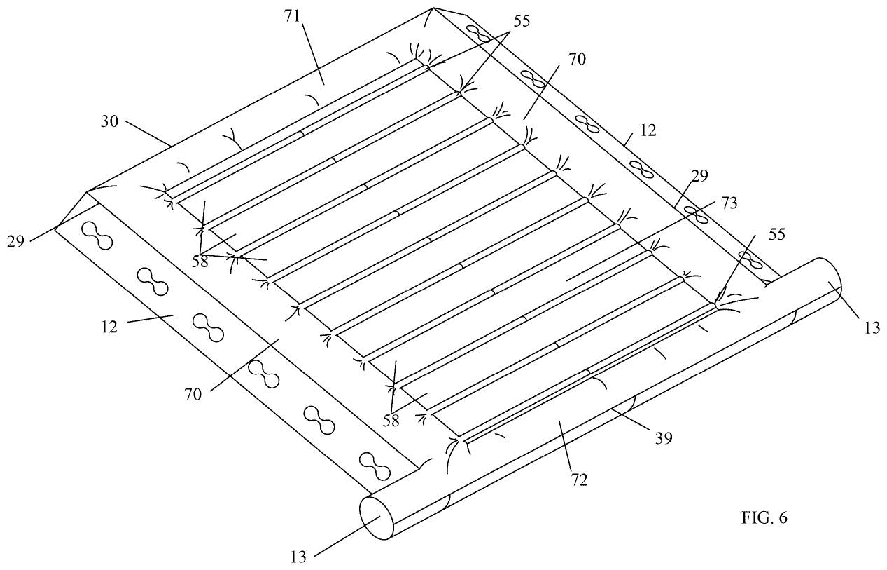

In one feature, each manifold sock 35a, 35b includes two openings 38a, 38b, respectively, that face the interior of the inflatable body 11. The two openings 38a, 38b are specifically positioned to feed pressurized air directly into pontoon portions 70 (FIG. 6) of the inflatable body 11 when the body is fully inflated. In one embodiment, each manifold sock 35a, 35b can have an effective diameter of 2.5-3 inches to accept a standard pump hose. The two openings 38 a, 38 b in the respective manifold socks can have a diameter of 2.0-2.5 inches to provide unimpeded air flow into the pontoons. It is understood that when a pump hose is connected to one inlet, such as inlet 36a, air only flows into the corresponding manifold sock 35a, while the other manifold sock 35b does not receive any air and remains uninflated. Moreover, air in the one manifold, such as manifold sock 35a, inflates that manifold sock, thereby compressing the other manifold sock 35b against the top sheet 21 (or the bottom sheet 20 if the manifold sock 35b is inflated), thereby preventing air flow through the manifold sock that is not connected to the air supply. With this construction, air enters the apparatus 10 through one inlet, such as inlet 36a, and the corresponding manifold sock 35a inflates to seal the other manifold sock 35b and inlet 36b.

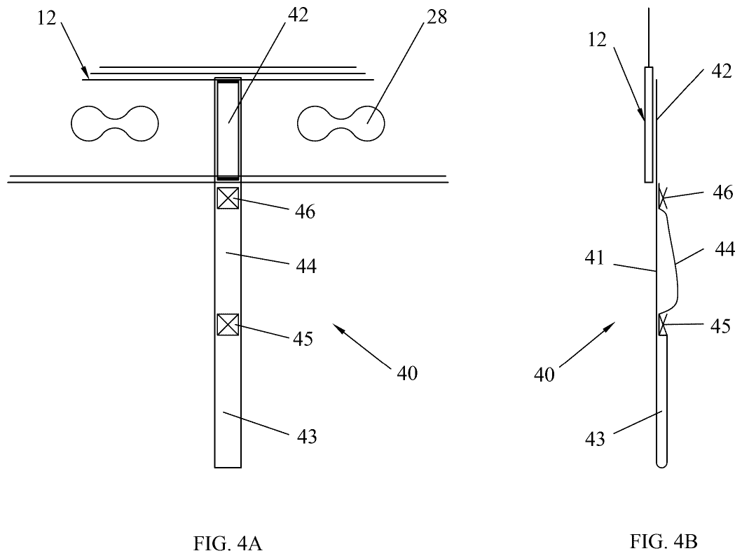

Returning to the side strips 12, the handles 28 defined in the side strips provide one feature for moving the patient support and transfer apparatus 10, but not the primary means for movement. The primary means for movement are the strap handles 40 affixed to the side strips 12. In the illustrated embodiment of FIG. 1, two such strap handles 40 are provided on each side and are spaced apart roughly shoulder-width to be grasped by one person. As shown in FIGS. 4A, 4B, the strap handles 40 are formed by a single strip 41 that is anchored at a base 42 to the side strip 12. In particular, the base 42 can be sewn through all of the layers of the side strip (see FIG. 3) so that the strap 41 is firmly anchored to the apparatus 10. The strap 41 is then folded onto itself and sewn to itself at location 45 to form an end loop 43. The strap is also sewn to itself at location 46 to form an intermediate loop 44. The strap is folded and sewn so that the two loops 43, 44 can receive a person's hand to allow the strap handles 40 to be grasped by the medical personnel. In use, the end loops 43 of the strap handles 40 on one side of the patient support and transfer apparatus 10 can be grasped by a person and then pulled toward that person to shift the position of a patient lying on the apparatus 10. In the case of a patient transfer, the strap handles on the one side would be used to move the patient from one surface to another, such as from a bed to a gurney. The strap handles thus have a length from the outer perimeter of the inflatable body to the end of the end loop 43 that allows at least the end loop to be grasped by a person reaching across the apparatus. In one embodiment, the handles have a length of 12-14 inches, with the base 42 having a length of 2-4 inches, so that the length of the strap handles that can extend over the top of the apparatus is at least 10 inches (254 mm). The strap handles 40 can be formed of a strong fabric, such as nylon or similar material.

In another use case, the apparatus 10 is used to shift the position of the patient on the same surface. For bed-ridden patients, protocols have been provided to avoid the formation of pressure wounds, or bed-sores. In particular, the protocols involve shifting or tilting the patient to one side or the other to alleviate the sitting pressure on limited areas of the patient's body. Thus, a patient that has been lying on his/her back for an extended period can be shifted or tilted to one side or the other, and held in that position by wedges placed between the patient and the bed or apparatus 10. In this instance, the strap handles 40 on the opposite side of the apparatus from the care-giver, are grasped by the care-giver and pulled toward the care-giver to tilt the patient. Since the care-giver must reach over the patient to grasp the strap handles it is not always possible for the caregiver to start the task. In this instance, a caregiver on one side can grasp the intermediate loops 44 of the handles on the caregiver's side of the apparatus, and extend the strap handles toward a second care-giver on the opposite side of the apparatus 10. The second care-giver can grasp the end loops 43 and the first care-giver can release the intermediate loops 44. The second care-giver can then pull the strap handles 40 by the end loops 43 toward the second care-giver, thus tilting the patient. Of course, it is contemplated that the first caregiver can grasp the end loops 43 and the second caregiver can grasp the intermediate loops 44 to effect the transfer of the handles from the caregiver on one side to the caregiver on the opposite side. The use of strap handles on the opposite side of the patient adds a mechanical advantage since the second care-giver can use his/her body weight to help pull the strap handles, and thus the opposite side of the apparatus 10, toward him/her. In contrast, the first care-giver would have had to lift the straps upward in order to shift the patient's position, which is a physical impossibility for nearly every care-giver.

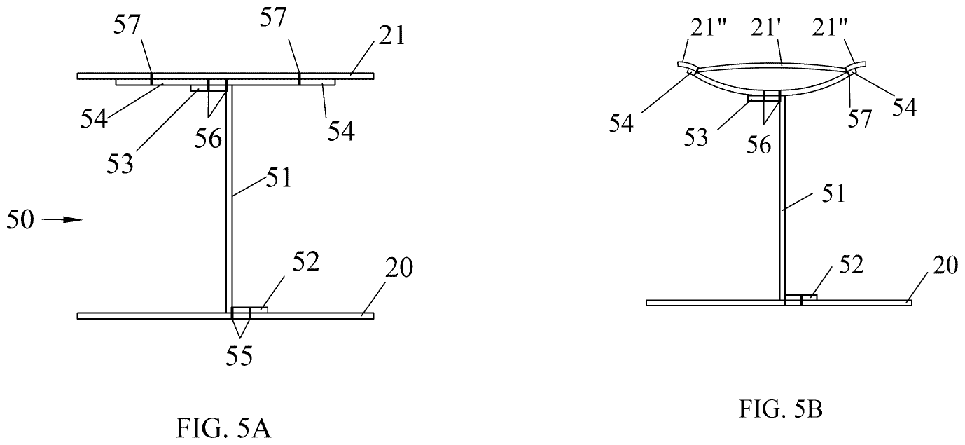

As shown in FIGS. 1A, 1B, the patient support and transfer apparatus 10 includes a center structure 49 that controls the separation between the bottom and top sheets 20, 21 during inflation. In particular, the structure 49 includes a plurality of Y-shaped baffles 50 attached between the two sheets, as shown in detail in FIG. 5. Each baffle 50 includes a stem 51 with a stem base 52 that is connected to the bottom sheet 20 by stem stitching 55. In the illustrated embodiment, two rows of stitching 55 fixes the stem base to the bottom sheet. As shown in FIG. 1, the parallel stitching 55 identifies the location of the base 52 of each baffle 50. The opposite end of the stem 51 includes a gusset 53 that is fastened to arms 54 by stitching 56. Again, two rows of stitching 56 can be used to attach the arms 54 to the stem 51. The arms 54 are fastened adjacent a distal end portion thereof to the top sheet 21 by stitching 57, which is visible at the upper surface of the top sheet, as shown in FIG. 2. The stem 51 can be bent at its opposite ends to form the stem base 52 and the gusset 53. Each arm 54 has a length that is about three times greater than the length of the base 52.

When the inflatable body 11 is inflated, the stem 51 and Y-shaped arms 54 limit the separation of the top sheet 21 from the bottom sheet 20, with the limit being the height of the stem and the separation of the top sheet from the arms 54. As shown in FIG. 5B, the arms are wider than the gusset 53 and the stem base 52. The arms are pulled upward slightly by the top sheet 21 during inflation to form a Y-shape between the stitching 57 and the stitching 56. The portion of the sheet 21′ between the stitching 57 bows out slightly, as do the portions 21″ to the left and right of the stem 51. The amount of inflation of the portions 21″ is limited by the distance 58 to the next baffle 50 along the length of the inflatable body 11. The center structure 49 is thus a portion in the center of the inflatable body 11 that does not inflate to the full extent of the body. As shown in FIG. 1, eight baffles 50 are provided in the center of the inflatable body.

The width of the center structure 49, and restrained center portion 73, is limited relative to the total width of the inflatable body 11 between the side strips 12. The baffles 50 are strips having a length W (FIG. 2) which is less than the dimension D between the side strips 12. When the inflatable body 11 is inflated, the baffles 50 of the center structure 49 create inflated side pontoons 70 between the lateral ends of the baffles and the side panels 12, as shown in FIG. 6. As explained above, the outlet openings 38 of the intake manifold 13 are aligned along the longitudinal axis of the pontoons so that air provided at the inlet ports 36 is fed directly into the pontoons, thereby facilitating inflation of the pontoons and maintaining the desired level of inflation of the pontoons during use. The space between the last baffle and the seam 30 at the head of the apparatus 10 forms a head end pontoon 71. The space between the last baffle at the foot end and the intake manifold 13 forms a foot end pontoon 72. The space delimited by the baffles of the center structure 49 forms restrained center portion 73. The center portion of the inflatable body 11 is restrained from its maximum inflation capability by the baffles affixed between the bottom and top sheets 21, 22. The baffles 50 are spaced apart by a dimension 58 of 3.75 inches.

The pontoons 70-72 of the apparatus 10 provide a “cocooning” effect for the patient as the inflatable body 11 is inflated. The patient is initially positioned in the restrained center portion 73. As the body 11 is inflated, the pontoons 70-72 expand and, in particular, the side pontoons 70 form a wall to the sides of the patient to help retain the patient in the center portion. As the side pontoons 70 are further inflated, they nestle against the patient to provide the cocooning effect that increases the patient's comfort and safety as and after the apparatus 10 is inflated. The apparatus 10 of the present disclosure can be inflated to 0.1-0.3 psi (0.73-2.08 kPa), during normal usage of the apparatus. In accordance with the present disclosure, optimization of the cocooning effect is achieved for certain dimensional relationships between the height and width of the baffles, the lateral width L (FIG. 2) of the uninflated side pontoons 70, as measured between the end of the baffles and the seam 29 (which attach the side strips 12 to the bottom and top sheets 20,21), and the inflated height of the side pontoons 70.

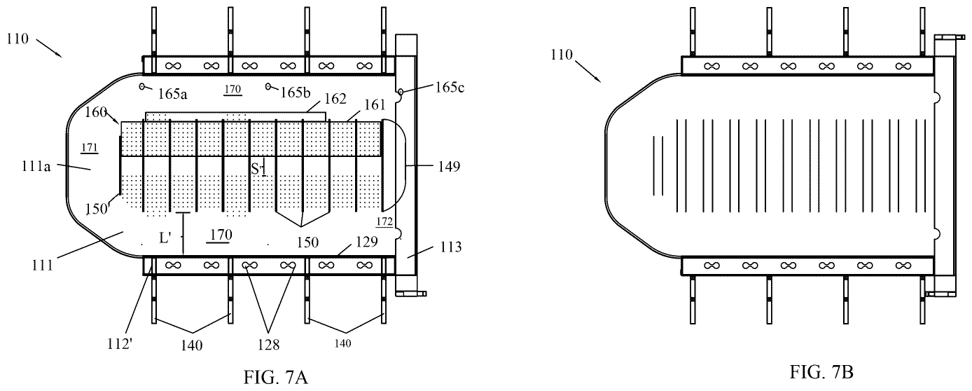

The dimensional relationships start with the dimensions of the baffles 50. In accordance with the present disclosure, in the embodiment of FIGS. 1 and 7A-7B, the stems 51 have a height of 3.0 in. (75 mm). The arms 54 that form the Y-shape for the baffles each have a length from the stem 51 to the stitching 57 that is about one-third of the height of the stem, or 1.0 in. (25 mm) in this embodiment. When the inflatable body 11 is fully inflated for normal use, such as to 0.2 psi (1.4 kPa), the height of the center portion 73, as measured between the bottom sheet 20 and the portions 21'′ of the top sheet, ranges from 5.9-6.2 inches (150-158 mm). It has been found that an inflated height, and effective diameter, of the side pontoons 70 that is 1.2-1.3 times the inflated height of the center portion 73 provides optimum cocooning for the patient while also offloading pressure on the reclined patient that can lead to pressure sores. A height greater than that range makes the pontoon too large for a patient to be comfortably positioned on the apparatus 10. A height less than that range is not sufficient for the patient's security, namely to prevent the patient from accidentally moving off of the apparatus when being transported.

The optimum inflated height of the pontoon 70 relative to the center portion is based on the relationship of the lateral width L of the uninflated side pontoons to the width W of the baffles. In the embodiment shown in FIGS. 1-2, the width W of the baffles 50 is 17.3 in. (440 mm). The lateral width L of each uninflated pontoon 70 is 8.0-8.5 in. (210-216 mm). The optimum ratio of the pontoon width L to the baffle width W is 0.48-0.60, which yields the desired inflated height of the side pontoons 70 for optimum cocooning of the patient lying on the inflated apparatus 10.

In one feature of the apparatus 10, air holes or bleed holes are provided in the bottom sheet 20 of the inflatable body 11. The bleed holes essentially leak air from the inflated apparatus 10 to create an air cushion beneath the patient that facilitates movement of the apparatus to transfer a patient from one surface to another. The bleed holes help maintain an optimum pressure distribution throughout the inflated body 11 even as the patient's weight shifts on the apparatus or as the apparatus shifts during the transfer.

In accordance with the present disclosure, the bleed holes are provided in two aperture arrays 60 defined at opposite sides of the center structure 49, as shown in FIG. 1. In particular, the two aperture arrays overlap the lateral sides of the baffles 50 and are separated at the middle of the baffles by a dimension S measured between the centers of the inboard apertures in each aperture array. In one embodiment, the dimension S is 5.4 in. (138 mm). This positioning of the aperture arrays allows the air to bleed out at the heaviest portions of the patient and concentrates the air cushion underneath these heaviest portions of the patient where the reduction of friction provided by the air cushion is most needed.

Each aperture array 60 includes two segments-a center segment 61 and a pontoon segment 62. The center segment 61 is disposed entirely within the center structure 49 and bounded by the baffles 50. The center segment includes a predetermined number and arrangement of apertures 63, namely 30 (thirty) apertures between adjacent baffles, arranged in lateral rows of 6 (six) apertures and lengthwise columns of 5 (five) apertures, with the apertures spaced apart 1.0 in. (25 mm.) along each row and column. The center segment 61 thus includes seven such arrangements of 30 apertures disposed between the eight baffles along the length of the apparatus 10. In the illustrated embodiment, the apertures 63 have a diameter of (0.05 in. (1.2 mm) that is sized for a calibrated flow of air from the pressurized inflatable body 11 based on the number and density of apertures in the center segment 61. The seven arrangements of 30 apertures for two center segments 61 provides 420 apertures in the center structure 49. In the illustrated embodiment, each center segment 61 of each aperture array 60 occupies an area of 204 in.² (34 in. long and 6 in. wide). Each of the two center segments includes 210 apertures (7 arrangements with 30 apertures 63) so the aperture density for each center segment is approximately 1 aperture for every square inch of the center segments 61. When the area of the entire center structure 49 is considered, the aperture density is 1.8 apertures per square inch of area of the center structure. This density of apertures in the center segments 61, and particularly in the center structure 49, allows the restrained center 73 of the inflatable body 11 to maintain enough pressure to offload a patient from the apparatus 10 without creating substantial pressure that could lead to patient injury.

In another aspect of the patient transfer apparatus 10, the aperture arrays 60 on each side of the center structure 49 includes a pontoon segment 62 adjacent and outboard of the center segment 61, as shown in FIG. 1. The pontoon segment 62 extends along the length of the center structure between the baffles 50 at the head end and the foot end of the apparatus 10. The apertures 64 in the pontoon segments 62 do not extend across the entire width L (FIG. 2) of the pontoon, but instead are arranged in two or three rows of apertures in each of the seven aperture arrangements along the length of the apparatus. Thus, as shown in FIG. 1, two lateral rows of five (5) aperture each extends from the aperture arrangement at the foot end of the apparatus, followed by, in sequence: three lateral rows, two sets of two lateral rows, three lateral rows and ending with two sets of two lateral rows. Thus, each pontoon segment 62 includes 80 apertures in communication with each side pontoon 70 (FIG. 6). Like the apertures in the center segment 61, the apertures in each pontoon segment 62 have a diameter of 0.05 in. (1.2 mm) and are spaced 1.0 in. (25 mm) apart. Since the patient will typically not be positioned on a side pontoon 70, there is no significant benefit provided by incorporating apertures between the lateral side of each pontoon segment 62 and the associated side strip 12. Without the weight of the patient pressing down on the side pontoons there would be little, if any, air flow through apertures in those regions as the inflatable body 11 is being deflated.

Although the apertures in the pontoon segments 62 provide air flow when the apparatus is fully inflated, these apertures do not generate a significant air cushion because the patient is not generally oriented over the pontoons. Nevertheless, the apertures of the pontoon segments 62 allow the side pontoons 70 to act as a cushion when the patient is being turned using the apparatus. As the patient is tilted, the patient's weight is forced onto the side pontoon so that air is forced out of the apertures in segment 62, which causes the side pontoon to slowly deflate. This controlled deflation of the side pontoon 70 allows the patient to still be offloaded on the apparatus and reduces or eliminates the tendency of a fully inflated pontoon to dislodge the patient from the bed. The controlled deflation during the turning process is also comforting to the patient as the patient “sinks into” the apparatus. The apertures in the pontoon segments 62 are also provided to reduce the amount of time that it takes to remove the air from the inflatable body 11 of the apparatus 10 to put the patient back on a stable surface, such as the surface of the bed or gurney, as the apparatus is deflated. However, the controlled outflow also maintains sufficient pressure within the pontoons 70 to offload the patient while the apparatus 10 is in use. To achieve these benefits from the apertures of the pontoon segments 62, the apertures are provided at a density of one aperture for every 10.5 in.² area of the side pontoons 70 for the embodiment of FIGS. 1-2.

However, it is appreciated that it is difficult to fully deflate any inflatable body, including the body 11 of the patient support apparatus 10. Of course, it is possible to squeeze residual air out of an inflatable body, but the common techniques for removing residual air cannot be used on the patient support apparatus 10 when the patient is lying on the apparatus. Moreover, in a hospital setting, time is often of the essence, so the medical personnel really do not have time to waste on squeezing out residual air. To address this problem, the support apparatus 10 of the present disclosure incorporates isolated apertures 65a, 65b, 65c in the bottom sheet 20 at the side pontoons 70. In the embodiment of FIG. 1, the three isolated apertures are spaced across the length of the side pontoon 70, with two apertures 65a, 65c near the corners of the pontoon, and the third aperture 65b in the middle of the pontoon. The isolated apertures are inboard of the side strips 12 but closer to the side strips and handles 40 than to the restrained center portion 73 of the inflatable body. In one embodiment, the apertures 65a-65c are positioned inboard at a distance of about 6.75 in. (171.5 mm) from the outside edge of the side strips. This positioning of the isolated apertures makes it less likely that the apertures will be inadvertently occluded by the top sheet 21 of the inflatable body as the body becomes deflated. In certain embodiments, the isolated aperture 65c adjacent the intake manifold 13 can be aligned with the outlet openings 38 in the manifold to facilitate removal of residual air in the manifold during deflation.

The patient support and transfer apparatus 10 of the embodiment shown in FIGS. 1-2 is primarily configured for patients within a certain size and weight range. Thus, in one specific embodiment, the structure of the apparatus 10 is configured to support a patient weighing up to 600 lbs. The air pressure applied to the apparatus is adapted to provide a sufficient cocooning effect when the patient is resting, as well as when the patient is being transferred. In the latter instance, the air pressure provided to the apparatus is increased so that air exiting the aperture arrays 60 provides an air cushion that reduces the friction between the bottom sheet 20 and the surface to facilitate the lateral transfer of the patient. For the embodiment of FIG. 1, the nominal air pressure is 0.2 psi (1.4 kPa), with an expected range of 0.1-0.3 psi (0.73-2.08kPa), depending on the weight of the patient occupying the apparatus. It is appreciated that the seams and stitching that mate the bottom and top sheets 20, 21 to form the inflatable body 11, and that attach the handles 40 to the body, are sufficiently strong to handle the weight of the patient. For that matter, the seams and stitching are adapted to handle heavier patients and provide a significant safety factor to ensure that the seams and stitching do not fail when the patient is resting on the apparatus or the apparatus is being used to transfer the patient.

As discussed above, pressurized air is fed into the apparatus 10 through the intake manifold 13, and particularly through the pair of openings 38a, 38b in one of the socks 35a, 35b, depending on which sock is connected to the air pump. As long as pressurized air is fed to the apparatus, air is continuously discharged through the aperture arrays 60 in the bottom sheet. The rate of the air discharge is controlled by the total cross-sectional area of the apertures in the arrays. In the embodiment of FIG. 1, the two center segments 61 include 420 apertures, while the two pontoon segments 62 include 160 apertures, for a total of 580 apertures. Thus, for the apparatus 10 the ratio of the number of apertures in the center segment to the number of apertures in the pontoon segments is 2.6. The diameter of each aperture is 0.05 in. (1.27 mm), so the cross-sectional area, or flow area, of each aperture is 0.002 in² (1.29 mm²). Thus, the total flow area of the aperture arrays 60 is 1.16 in 2 (748 mm²). The air enters the interior volume of the apparatus 10 through two openings 38 a or 38b, each having a diameter of 2-2.5 inches, or a flow area of 3.1-5.0 in². The total flow area of the two openings is thus 6.2-10.0 in². The ratio of the inflow area (of the two manifold openings) to the outflow area (of the aperture arrays) is 5.3-8.6. This ratio of inflow area to outflow area ensures that the air discharged from the aperture arrays provide a sufficient air cushion to move the patient with the inlet air pressure range of 0.1-0.3 psi (0.73-2.08 kPa).

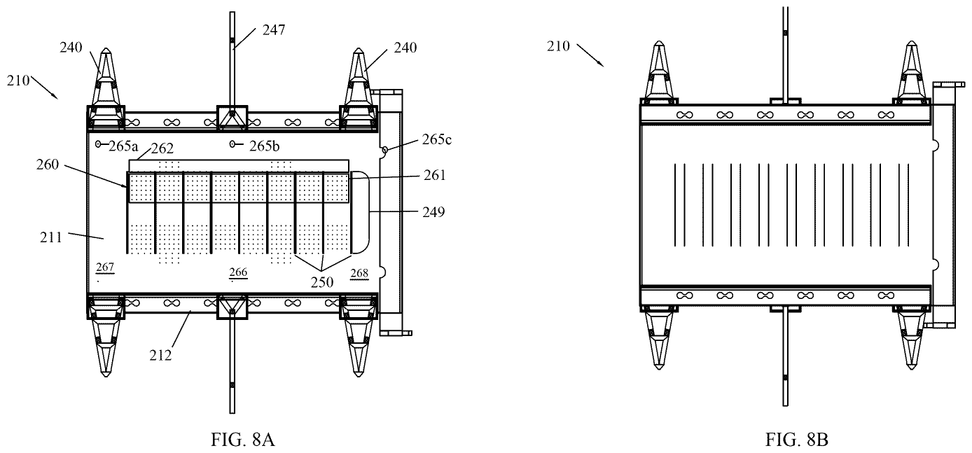

The features of the transfer apparatus 10 can be incorporated into apparatuses that provide other features. For instance, the transfer apparatus 110 shown in FIGS. 7A-7B incorporates features of the apparatus 10 but adapted for large patients, weighing up to 1200 lbs. The air pressure applied to the apparatus 110 is nominally less than the air pressure for the smaller apparatus 10, with a nominal pressure of 0.12 psi (0.84 kPa) and a pressure range of 0.09-0.15 psi (0.60-1.09 kPa). Since the apparatus 110 is larger than the apparatus 10, applying the same air pressure to the larger apparatus 110 would produce undesirably larger pontoons. The transfer apparatus 210 of FIGS. 8A-8B incorporates features of the apparatus 10 but configured for lifting the patient using a hanger bar. The apparatus 210 can be inflated to the same nominal pressure as the apparatus 10.

As shown in FIGS. 7A-7B, the apparatus 110 includes an inflatable body 111, side strips 112 and an intake manifold 113. The side strips 112 are substantially similar to the side strips 112, including the multi-layer construction (FIG. 3) and the dog-bone handles 128. However, since the apparatus 110 is intended for heavier patients, additional straps 140 are provided, the straps 140 being constructed the same as the straps 40 (FIGS. 4A, 4B). The straps 140 are provide in two pairs, with the two straps in each pair spaced apart a comfortable distance to be grasped by a single caregiver. The intake manifold 113 is configured the same as intake manifold 13, albeit wider.

The inflatable body 111 is constructed in the same manner as the body 11, albeit wider and longer. The body 111 includes a head portion 111a that effectively extends the overall length of the apparatus 110 relative to the apparatus 10. The head portion 111a is tapered inward since it is not supported by the side strips as is the remainder of the inflatable body. The inward taper adds some geometrical stability to the head pontoon 172 when the body is inflated. The inflatable body includes ten rows of baffles 150 configured like the baffles 50 with the same width as the baffles 50. However, the overall width of the inflatable body 111 is greater than the width of the inflatable body 11 so that the distance between the outboard ends of each baffle 150 and the innermost stitching 129 of the side strip 112 is greater than for the apparatus 10. This increased distance produces a larger lateral portion and thus a larger side pontoon 170 in the apparatus 110. In one embodiment, the overall width of the inflatable body 111 and side strips 112 is 48 inches and the dimension between the innermost stitching 129 of the side strips 112 is 39 inches. Thus, the lateral portions that form the side pontoons 170 have a lateral width L′ of 10.75 in. (273 mm), so that the ratio between the baffle width and the width L′ of the uninflated side pontoon is about 0.6.

The overall length of the apparatus 110 is 78 inches (1981 mm), so the center structure 149 includes more baffles than the apparatus 10. The ten baffles 150 are spaced apart the same dimension as the baffles 50, namely 3.75 inches (95.25 mm). The end-most baffle at the foot end of the apparatus 110, or adjacent the intake manifold 113 is closer to the manifold than in the apparatus 10, which leads to a foot end pontoon 171 is minimal. The head end pontoon 171 is larger for the apparatus 110 than for the apparatus 10 due to the extended head portion 111a. In order to limit the width of the head end pontoon 171, an additional baffle 150′ is provided at the head end of the inflatable body. Since the head portion 111a is tapered, the baffle 150′ has a smaller width than the other baffles 150. In the embodiment of FIGS. 7A-7B, the head end baffle 150′ has a width of 12.5 in. (315 mm), rather than the 17.3 in. (440 mm) width of the other baffles.

Like the apparatus 10, the apparatus 110 includes an aperture array 160 that serves the same function as the aperture array 60. In this embodiment, each of the two center segments 161 include nine sets of apertures between the ten baffles 150, each set having five rows and eight columns for 40 apertures. Another set of apertures is provided between the end-most baffle 150 and the additional baffle 150′ that includes six columns with five rows of apertures and then two successive columns with one less aperture in each column, for a total of 37 apertures in this set. Thus, each center segment 161 for the apparatus 110 includes 397 apertures. Due to the addition of two columns of apertures in the inflatable body 111, the dimension S′ between center segments is less than the dimension S for the inflatable body 11. Thus, in the embodiment of FIGS. 7A-7B, the dimension S′ is 4.7 in. (120 mm). The pontoon segment 162 includes two columns of apertures, as opposed to the three columns in the pontoon segment 62 of the apparatus 10. The pontoon segments 162 of the apparatus 110 includes three sets of apertures, spaced apart by three baffles 150, with each set including eight apertures, for a total of 24 apertures in each pontoon segment. The aperture array 160 in the apparatus 110 of this embodiment is modified relative to the apparatus 10 because the apparatus 110 is intended to support a much heavier patient. Thus, more apertures are required in the center segment 161 in order to generate a meaningful air cushion between the apparatus and the bed surface to facilitate lateral transfer of the patient. Moreover, the heavier patient will exert more pressure on the inflatable body 111 to push air out of the apertures in the pontoon segment 162, so fewer apertures are required in that segment to maintain the same level of controlled expulsion of air as in the apparatus 10 intended for lighter patients. The aperture arrays 160 of the embodiment of FIG. 7A-7B includes the 397 apertures in each of the two center segments 161 (for a subtotal of 794) and the 24 apertures in each of the two pontoon segments 162 (for a subtotal of 48), for a total of 842 apertures. Thus, for the apparatus 110 the apertures are in the ratio of slightly more than 16 apertures in the center segment for every pontoon aperture. The total outflow area of the aperture arrays 160 is thus 1.7 in² (1097 mm²). For the inflow areas of 6.2-10.0 in², the inflow-to-outflow ratio for the heavy patient embodiment is 3.7-5.9. This inflow-outflow ratio for the embodiment of FIGS. 7A-7B is significantly less than for the embodiment of FIG. 1 because greater air outflow is necessary to provide an air cushion that is sufficient to move the heavier patient.

Like the apparatus 10, the apparatus 110 includes three isolated apertures 165a, 165b, 165c arranged to facilitate the removal of residual air when the inflatable body 111 is being deflated. The isolated aperture 165a is located adjacent the head portion 111a but could be moved farther into the head portion.

As noted above, the transfer apparatus 200 of FIGS. 8A-8B incorporates features of the apparatus 10 but configured for lifting the patient using a hanger bar. Like the other apparatuses 10, 110, the apparatus 210 includes an inflatable body 211 that is constructed like the body 11, albeit slightly longer than the body 11 in order to provide sufficient separation between lifting straps 240 to engage conventional hanger bars used to lift and transport a patient. Thus, the apparatus 210 can have a length of 67 inches (1701 mm). Due to the added length of the apparatus 210 over the apparatus 10, the center structure 249 includes nine baffles 250, rather than eight baffles 50. The baffles 250 are otherwise constructed in the same manner as the baffles 50 and 150, but are slightly larger. In the embodiment of FIGS. 8A-8B, the vertical stem is 3.9-4.0 inches (99-101 mm) and each arm of the Y-shape has a length of 1.45-1.50 inches (37-38 mm). In this embodiment, the side pontoons 266, front end pontoon 267 and foot end pontoon 268 of the apparatus 210 are configured like the pontoons 70, 71 and 72 of the apparatus 10, with the same overall dimensions. Given the larger baffle height, the inflated height of the center portion of the apparatus 210 is greater than in the two previous embodiments. In particular, the center section within the center structure 249 has an inflated height of 6.5-6.8 inches (165-172 mm).

The aperture array 260 of the apparatus 210 includes a pair of center segments 261 and a pair of pontoon segments 262, each extending along the length of the center structure 249 between the head-end and foot-end baffles 250. The center segments include eight sets of thirty apertures, arranged in the same manner as the apertures in the center segment 61, for a total of 240 apertures in each center segment. However, the apparatus 210 includes fewer apertures in the pontoon segment 262 than in the pontoon segment 62 of the apparatus 10. In this embodiment, the apertures are arranged in two T-shaped arrangements of 20 apertures each, for a total of 40 apertures in each pontoon segment. Thus, the apparatus 210 includes a total of 480 apertures in the center segment and 80 apertures in the pontoon segments, for a ratio of 6 center apertures for each pontoon aperture. The two arrangements are situated between the straps 240, 247, as shown in FIG. 8A. This location of the apertures in the pontoon segments 262 allow the side pontoons 266 to maintain a sufficient degree of inflation as the apparatus and patient are lifted by the lifting straps 240. The aperture array 260 also includes the isolated apertures 265a-265c to facilitate full deflation of the inflatable body 211. The aperture array 260 of this embodiment includes a total of 560 apertures for an outflow area of 1.12 in². The inflow-outflow ratio is 5.5-8.9, which is slightly greater than the ratio for the embodiment of FIG. 1. In this embodiment, the need for air outflow is less critical since the apparatus 210 is provided with lifting straps 240.

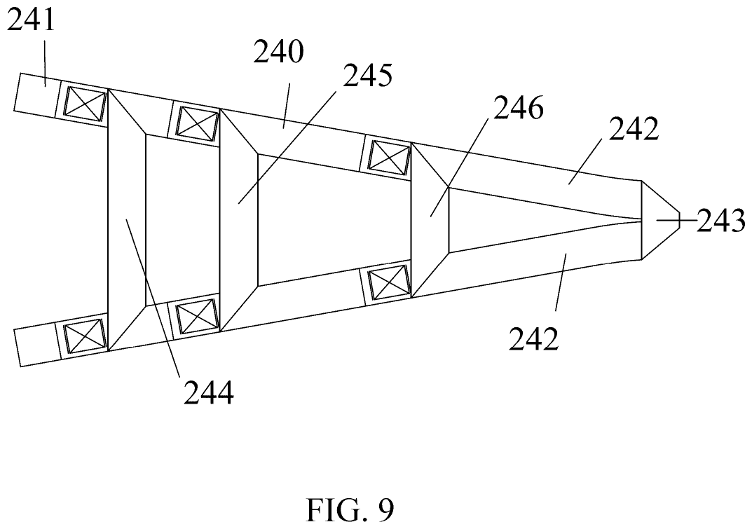

The apparatus 210 includes a pair of lifting straps 240 situated at the foot and head ends of the inflatable body 211. A pair of lifting straps are provided on opposite sides of the apparatus at the head-end and a pair of lifting straps are provided at the foot-end. Each pair of straps 240 are configured to engage a lifting bar extending across the width of the apparatus. As shown in FIG. 9, each strap 240 includes an anchor portion 241 that is fastened to the side strips 12 in the same manner as the straps 40 described above. The strap includes a pair of legs 242 that extend from the anchor portion 241 to a tip 243. In one embodiment, the legs can be formed by a single strip that is folded over on itself at the tip 243, as shown in FIG. 9. The strap includes a series of rungs 244, 245, 246 spaced apart along the length of the strap. The end-most rung 246 defines the opening for receiving the lifting bar. The other two rungs 244, 245 can be grasped by the medical personnel to stabilize and move the patient. Each rung 244-246 can be formed by a single strip spanning the space between the legs 242 and anchored to the legs in the same manner that the legs are anchored to the side strips 212.

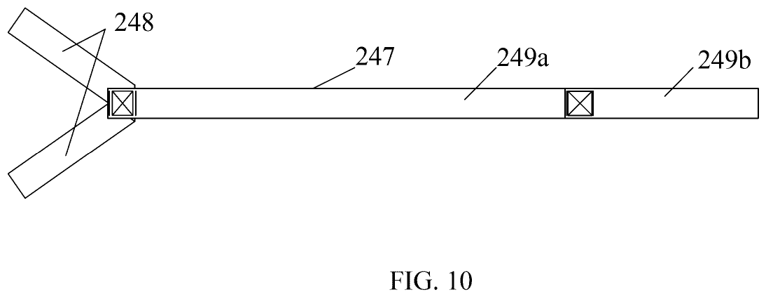

A center strap 247 is provided at roughly the midpoint between the two lifting straps. As shown in FIG. 10, the center strap 247 includes a pair of anchor legs 248 that are affixed to the side strips 212 in the same manner as the lifting straps 240. The center strap can include one loop 249a, or optionally two loops 249a, 249b, that can be grasped by the medical personnel to assist in lifting and transporting the patient using the lifting bar.

The apparatuses 10, 110 and 210 of the present disclosure have pre-defined numbers of apertures in the center segments and a much fewer number of apertures in the pontoon segments. The ratio of center apertures to pontoon apertures is at least 2.5, depending on the patient weights and uses. The apparatus 10 is provided for a “standard” range of patient weights up to 600 lbs. For this standard range, the ratio is 2.6. However, for much heavier patients, the ratio is 16 because a significantly greater proportion of the air outflow must be used to create the air cushion for moving the patient.

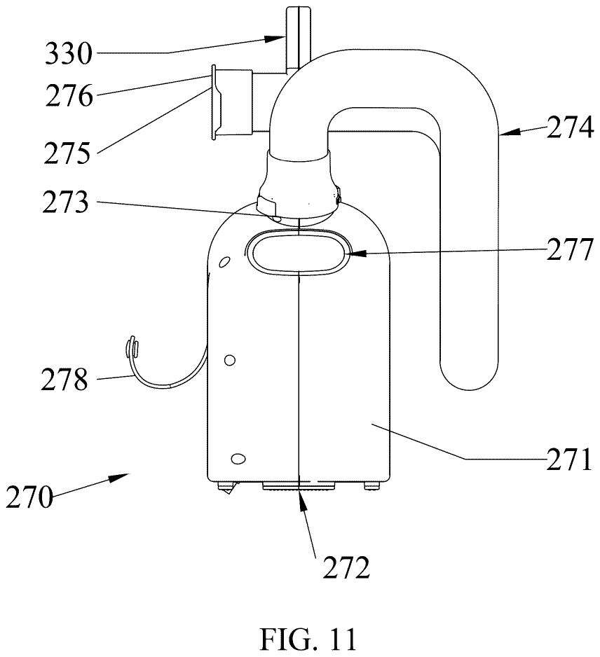

As described above, the inflatable body 11 of the support and transfer apparatus 10 is inflated to support the patient on a surface, such as a bed, to provide a cocooning effect for the comfort of the patient, and to assist in moving the patient laterally from one surface to another, such as a gurney. Thus, pressurized air is provided to the body 11 through the inlet openings 36 by engaging a pump tube to the openings using the straps 37. In particular, a pump 270 as shown in FIG. 11 can be connected to the inflatable body 11. The pump 270 includes a canister 271 that houses the pump motor and valve components. The canister defines an inlet 272 at the bottom the pump and an outlet 273 at the top that is configured to engage a flexible hose 274 in a conventional manner, such as with a bayonet mount. The inlet 272 and/or the outlet 273 can be provided with a removable filter element (not shown). The hose 274 includes an outlet 275 that is engaged with one of the inlet openings 36 of the apparatus. The outlet 275 includes a flange 276 that can be engaged by the strap 37 to hold the tube outlet within the inlet opening.

Controls 277 are provided for controlling the operation of the pump. In one feature, the controls include two push buttons—LOW, which provides a low air pressure and flow rate to the apparatus 10, and HIGH, which provides a greater pressure and flow rate. The medical personnel can select the appropriate operation level for the pump based on the use of the apparatus 10.

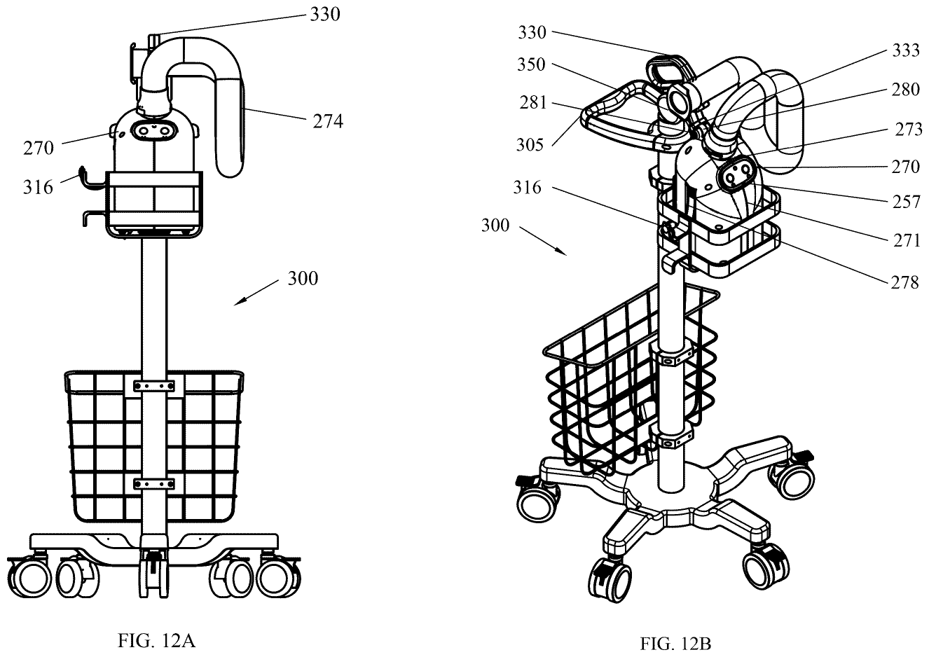

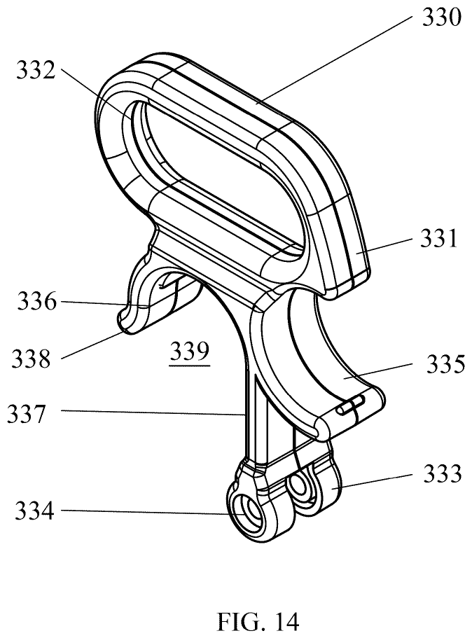

The pump 270 includes a strap 278 with a releasable end, such as a snap or a hook-and-loop fastener, for engaging the pump to the support frame 310 of the cart, as shown in FIGS. 12A-12B. The pump also includes a pivot bracket 280 and pivot pin 281 that engage a pivot mount 333 of a pump handle 330, as described in more detail herein with reference to FIG. 14.

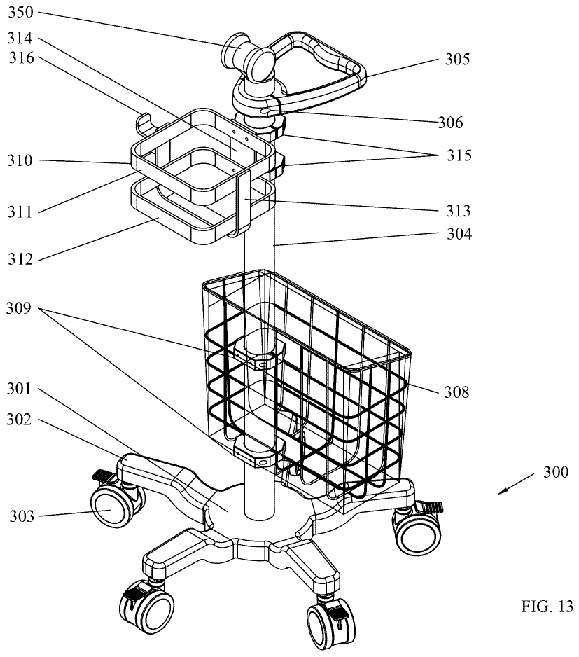

Although the pump 270 is relatively compact and light-weight, it is cumbersome to manipulate in a hospital setting. It is particularly beneficial to provide a cart, such as cart 300 shown in FIGS. 12A, 12B and 13, to carry the pump and any auxiliary items. The cart 300 includes a base 301 with a plurality of legs 302 radiating therefrom, each leg carrying a lockable caster wheel 303 that allows the cart to be easily moved in any direction. In the illustrated embodiment, the cart includes five legs 302 which provides a stable support for the pump that is not prone to being accidentally knocked over. A post 304 is mounted to the base and projects vertically upward to support the components of the cart. The post 304 can have a fixed height, such as 36-48 inches, or can have an adjustable height. A handle 305 is provided at the top of the post 304. The handle can include an integral mounting ring 306 for fastening to the top of the post in a conventional manner. The handle 305 extends generally horizontally from one side of the post so that the handle can be easily grasped by the medical personnel and used to move the cart. A wire basket 308 can be mounted to the post 304 with clamps 309. The basket is on the same side of the post as the handle so that the accessories and components stored in the basket can be readily accessed by the person maneuvering the cart 300.

A pump support frame 310 is mounted below the handle 305 at the top of the post 304. The frame is an open structure to allow the free flow of air into the inlet 272 of the pump 270. Thus, the frame is formed by two generally rectangular band structures 311, 312 that are sized to receive the pump canister 271, with the perimeter of the band structures exceeding the outer dimension of the pump canister so that the pump can be easily placed within and removed from the support frame 310 by essentially simply dropping the canister into the frame. A band 313 extends from the top band 311, around and across the lower band 312, and back up to the top band 311 to form the base for supporting the pump canister. The band 313 can define a clip 316 for carrying a coiled power cable for the pump. It can be appreciated that the single band 313 is sufficiently wide to support the canister, but also sufficiently narrow so that the band does not interfere with the air flow into the pump inlet. In one embodiment, the bands 311-313 can have a width of 1.5-2.0 inches. The frame 310 is mounted to the post 304 at a mounting plate 314 affixed to the two band structures 311, 312. A pair of mounting clamps 315 are affixed to the mounting plate and are configured to be clamped or fastened to the post 304 in a conventional manner.

In one feature, the pump 270 includes a pump handle 330 that can be fastened to the pump canister 271 and can be used to carry the pump 270 to and from the cart 300. As shown in FIG. 14, the pump handle 330 includes a one-piece molded body 331 that defines a grip portion 332 that can be grasped by the personnel to carry the pump. The body further defines a pivot mount 333 at the bottom of the handle with a bore 334 for receiving a pivot pin. As shown in FIG. 12B, the pump 270 can include a pivot bracket 280 fastened to the canister 271. A pivot pin 281 extends through the pivot bracket 280 and the pivot mount 233 so connect the pump handle 330 to the pump 270. The pivot bracket and pivot mount can be configured to allow limited pivoting movement of the pump relative to the handle to facilitate placement of the pump 270 into the pump frame 310. The body 331 forms a recess 335 between the grip portion 332 and the pivot mount 333. The recess 335 is sized to receive the flexible hose 274 in the manner shown in FIG. 12A, to contain the hose when the pump 270 is being moved with the cart 300.

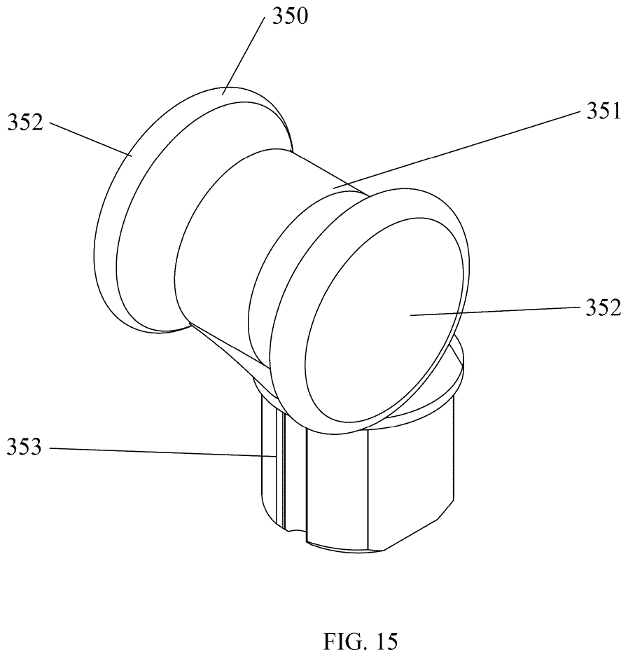

As shown in FIG. 12B, the pump handle 330 is used to support the pump 270 on the cart 300. In particular, the body 331 of the pump handle defines a hook 336 beneath the grip portion 332. The hook 336 is in the form of an inverted “J” shape, with the base 337 of the “J” connecting the pivot mount 333 to the grip portion. The hook end 338 of the “J” shape can be resiliently deflectable so that the hook opening 339 can be slightly expanded. The hook 336 is configured to engage a spool 350 shown in FIG. 15. The spool 350 includes a cylindrical body 351 that has a diameter that is slightly larger than the hook opening 339. The pump handle 330 can be pressed onto the spool 350 until the cylindrical body 351 is fully received within the hook 336. The spool 350 can include enlarged ends 352 to center the hook 336 on the cylindrical body of the spool. The spool includes a base 353 that is configured to be mounted onto the end of the post 304 of the cart, as shown in FIG. 13. The spool base 353 and the post 304 can be configured for a male-female engagement, or can integrally formed from a moldable material.

What is claimed is:

1. An assembly for supporting an air pump comprising:
a cart including;
a base with a plurality of wheels; and
a post projecting upward from said base, said post including a spool mounted to a distal end thereof, said spool having a cylindrical body arranged perpendicular to said post; and
a pump handle including a fastener portion for fastening to said air pump, said pump handle including a body defining;
a grip portion configured to be manually grasped by a user to carry the air pump fastened to said pump handle; and
a hook portion configured to removably engage said cylindrical body of said spool to support the air pump, fastened to said pump handle, on said post of said cart.

2. The assembly of claim 1, wherein:
said cylindrical body of said spool has a diameter;
said hook portion defines an opening with a diameter slightly less than the diameter of said spool; and
said hook portion is resiliently deflectable so that the opening of said hook portion can expand slightly to receive said spool.

3. The assembly of claim 2, wherein said hook portion includes a hook end curved outward from said opening to engage said spool to expand said opening.

4. The assembly of claim 2, wherein said hook portion is an inverted J-shape with the base of the J-shape extending between said grip portion and said fastener portion.

5. The assembly of claim 2, wherein:
said fastener portion of said pump handle includes a pivot mount;
the air pump is provided with a pivot bracket configured to mate with said pivot mount; and
said fastener portion includes a pivot pin configured to extend through said pivot mount of said pump handle and the pivot bracket of said air pump.

6. The assembly of claim 1, wherein said body of said pump handle further defines a recess configured to receive a flexible air hose connected to the air pump.

7. The assembly of claim 6, wherein said recess is disposed between said handle and said fastener.

8. The assembly of claim 1 further comprising a wire basket mounted to said post.

9. The assembly of claim 1, wherein said plurality of wheels are lockable caster wheels.

10. A pump handle for connection to an air pump, comprising a one-piece molded body defining:
a grip portion configured to be manually grasped by a user to carry the air pump connected to the pump handle;
a fastener portion configured for removable connection to the air pump; and
a hook portion integrally formed between said grip portion and said fastener portion, said hook portion defining a circular opening for mounting on a cylindrical body on a mobile cart to carry the air pump connected to the pump handle.

11. The pump handle of claim 10, wherein:
said hook portion is resiliently deflectable so that the opening of said hook portion can expand slightly to receive the cylindrical body.

12. The pump handle of claim 11, wherein said hook portion includes a hook end curved outward from said opening.

13. The pump handle of claim 10, wherein said hook portion is an inverted J-shape with the base of the J-shape extending between said grip portion and said fastener portion.

14. The pump handle of claim 10, in which the air pump includes a pivot bracket, wherein:
said fastener portion of said pump handle includes a pivot mount; and
the pump handle includes a pivot pin configured to extend through said pivot mount of said pump handle and the pivot bracket of the air pump.

15. The pump handle of claim 10, wherein said hook portion further defines a recess separate from said circular opening and configured to receive a flexible air hose connected to the air pump.
